(19) United States
(12) Patent Application Publication
(10) Pub. No.: US 2024/0305199 A1
(43) Pub. Date: Sep. 12, 2024

(54) POWER SUPPLY CONTROL DEVICE AND SWITCHING POWER SUPPLY

(71) Applicant: Rohm Co., Ltd., Kyoto (JP)

(72) Inventor: Kazuhiro MURAKAMI, Kyoto (JP)

(21) Appl. No.: 18/665,287

(22) Filed: May 15, 2024

Related U.S. Application Data
(63) Continuation of application No. PCT/JP2022/038732, filed on Oct. 18, 2022.

(30) Foreign Application Priority Data
Nov. 16, 2021 (JP) 2021-186324

(51) Int. Cl. H02M 3/158; H02M 1/08

(52) U.S. Cl. CPC H02M 3/158; H02M 1/08

(57) ABSTRACT

A power supply control device includes: a high-side gate driver that turns on and off an N-channel high-side transistor connected between an application terminal for an input voltage and an application terminal for a switching voltage; a bootstrap circuit that generates a bootstrap voltage, higher than the switching voltage by the charge voltage for a boot capacitor, to feed it to the high-side gate driver; and a controller that switches the switching power supply between a heavy-load mode and a light-load mode. The bootstrap circuit can switch the capacitance value of the bootstrap capacitor according to whether the high-side transistor is on or off. The controller controls the bootstrap circuit such that it, in the light-load mode, performs capacitance value switching control for the boot capacitor but, in the heavy-load mode, suspends capacitance value switching control for the boot capacitor.

### CROSS-REFERENCE TO RELATED APPLICATIONS

This nonprovisional application is a continuation application of International Patent Application No. PCT/JP2022/038732 filed on Oct. 18, 2022, which claims priority to Japanese Patent Application No. 2021-186324 filed on Nov. 16, 2021, the entire contents of which are hereby incorporated by reference.

### TECHNICAL FIELD

The disclosure herein relates to power supply control devices and switching power supplies.

### BACKGROUND ART

Today, switching power supplies are widely used as a means to supply electric power in a variety of applications.

One example of known technology related to the foregoing is found in Patent Document 1 identified below.

### CITATION LIST

### Patent Literature

Patent Document 1: JP-A-2018-57100

### BRIEF DESCRIPTION OF DRAWINGS

FIG. 1 is a diagram showing an overall configuration of a switching power supply.

FIG. 2 is a diagram showing a power supply control device according to a first embodiment.

FIG. 3 is a diagram showing a power supply control device according to a second embodiment.

FIG. 4 is a diagram showing one example of switching driving according to the second embodiment.

### DESCRIPTION OF EMBODIMENTS

### <Switching Power Supply>

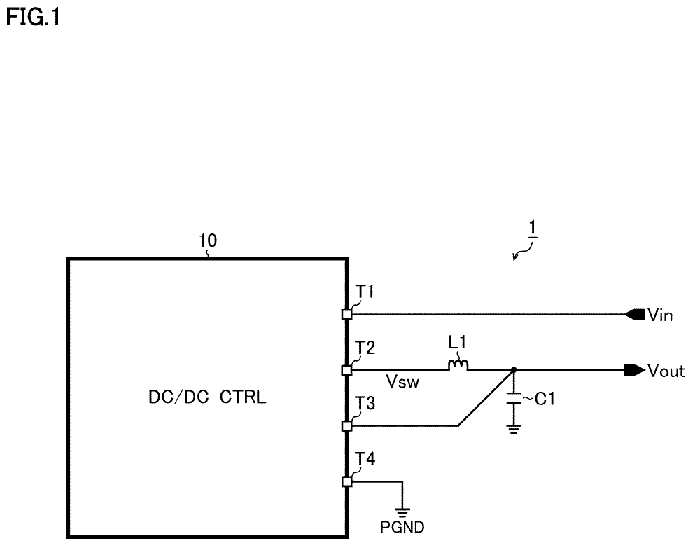

FIG. 1 is a diagram showing an overall configuration of a switching power supply. The switching power supply 1 of this configuration example is a non-isolated buck DC/DC converter (what is called a buck converter) that bucks (steps down) an input voltage Vin to generate an output voltage Vout. The switching power supply 1 includes a power supply control device 10 and various discrete components (an inductor L1 and a capacitor C1 in the diagram) externally connected to it.

The power supply control device 10 is a semiconductor device that serves as the controlling agent in the switching power supply 1. The power supply control device 10 also has, for communication with outside the device, a plurality of external terminals (external terminals T1 to T4 in the diagram).

The external terminal T1 (PVIN pin) is connected to an application terminal for the input voltage Vin. The external terminal T2 (SW pin) is connected to the first terminal of the inductor L1. The external terminal T3 (FB pin) is, along with the second terminal of the inductor L1 and the first terminal of the capacitor C1, connected to an application terminal for the output voltage Vout. Between the application terminal for the output voltage Vout and the external terminal T3, a voltage division circuit can be provided that generates a feedback voltage Vfb corresponding to the output voltage Vout. The external terminal T4 (PGND pin) and the second terminal of the capacitor C1 are both connected to a power-system ground terminal (i.e., an application terminal for a ground voltage PGND).

The power supply control device 10 drives the switching of (performs switching driving of) a switching output stage (unillustrated) incorporated in it such that the output voltage Vout (or feedback voltage Vfb) fed back to the external terminal T3 is equal to a desired target value. As a result, a switching voltage Vsw with a rectangular waveform appears at the external terminal T2. The inductor L1 and the capacitor C1 function as a rectifying-smoothing circuit that rectifies and smooths the switching voltage Vsw to generate the output voltage Vout.

### Power Supply Control Device (First Embodiment)

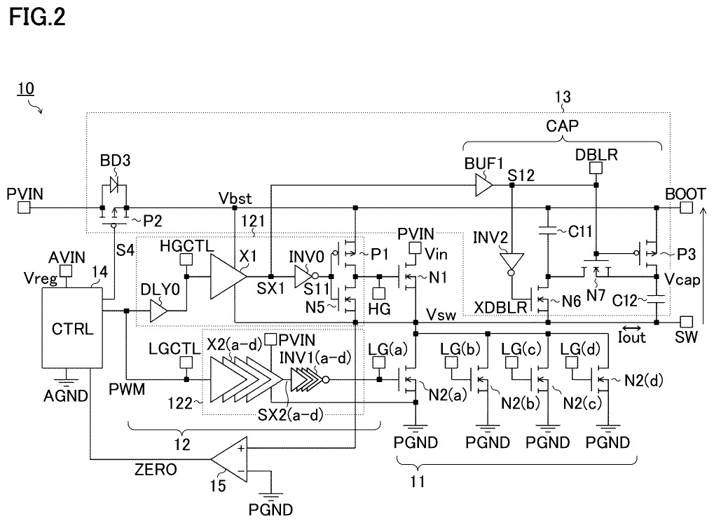

FIG. 2 is a diagram showing a power supply control device 10 according to a first embodiment. The power supply control device 10 of this embodiment has integrated in it a switching output stage 11, a driving circuit 12, a bootstrap circuit 13, a controller 14, and a zero-cross detection circuit 15.

The power supply control device 10 can include any functional blocks other than those mentioned above. For example, the power supply control device 10 can have integrated in it an internal reference voltage generation circuit, a communication I/O (input/output) circuit, a clock generation circuit, a self-diagnosis circuit, various fault protection circuits (UVLO [undervoltage lockout], OCP [overcurrent protection], OVD [overvoltage detection], UVD [undervoltage detection], SCP [short-circuit protection], and TSD [thermal shutdown]), and the like.

The switching output stage 11 includes a transistor N1 (e.g., an N-channel MOSFET [metal-oxide semiconductor field-effect transistor]) and transistors N2(a) to N2(d) (e.g., all N-channel MOSFETs).

The drain of the transistor N1 is connected to the application terminal for the input voltage Vin (i.e., the PVIN pin). The source of the transistor N1 is connected to the application terminal for the switching voltage Vsw (i.e., the SW pin). The gate of the transistor N1 is connected to an application terminal for a high-side gate driving signal HG. The transistor N1 is on when the high-side gate driving signal HG is at high level (≈Vbst), and is off when the high-side gate driving signal HG is at low level (≈Vsw). The transistor N1 functions as a high-side transistor (i.e., output transistor) in the switching output stage 11.

The drains of the transistors N2(a) to N2(d) are all connected to the application terminal for the switching voltage Vsw (i.e., the SW pin). The sources of the transistors N2(a) to N2(d) are all connected to the power-system ground terminal (i.e., the PGND pin). The gates of the transistors N2(a) to N2(d) are connected to application terminals for low-side gate driving signals LG(a) to LG(d) respectively. The transistor N2(a) is on when the low-side gate driving signal LG(a) is at high level (≈Vin), and is off when the low-side gate driving signal LG(a) is at low level (≈PGND).

A similar description applies to the transistors N2(b) to N2(d); that is, they respectively are on when the gate driving signals LG(b) to LG(d) are at high level (≈Vin), and are off when gate driving signals LG(a) to LG(d) are at low level (≈PGND).

As described above, the N transistors (where N>2; in the diagram, N=4) that are connected between the application terminal for the switching voltage Vsw (i.e., the SW pin) and the power-system ground terminal (i.e., the PGND pin) function as a low-side transistor (i.e., synchronous rectification transistor) in the switching output stage 11. In the following description, The transistors N2(a) to N2(d) and the low-side gate driving signals LG(a) to LG(d) are occasionally referred to collectively as the transistor N2 and the low-side gate driving signal LG respectively.

The transistors N1 and N2 are turned on and off complementarily according to the high-side and low-side gate driving signals HG and LG. This produces the switching voltage Vsw with a rectangular waveform that is pulse-driven between the input voltage Vin and the ground voltage PGND.

The term “complementarily” above covers not only operation in which the on/off states of the transistors N1 and N2 are completely reversed but also operation that includes a period (what is called a dead time) in which the transistors N1 and N2 are simultaneously off to prevent a through current.

The switching power supply 1 can employ any rectification method other than synchronous rectification; it can employ diode rectification. In that case, instead of the transistor N2, a rectification diode can be used.

The driving circuit 12 is a circuit block that drives the switching output stage 11 according to a pulse control signal PWM fed from the controller 14, and includes a high-side gate driver 121 and a low-side gate driver 122.

The high-side gate driver 121 is a circuit block that charges and discharges the gate capacitance (e.g., approximately 100 pF) of the transistor N1 by outputting the high-side gate driving signal HG in response to the pulse control signal PWM. The high-side gate driver 121 includes a delay circuit DLY0, a buffer X1, an inverter INV0, a transistor P1 (e.g., a P-channel MOSFET), and a transistor N5 (e.g., an N-channel MOSFET).

The delay circuit DLY0 generates a high-side pulse control signal HGCLT by giving a predetermined delay to the pulse control signal PWM (e.g., the timing at which it rises from low level to high level) so as to produce a period in which the transistors N1 and N2 are simultaneously off.

The buffer X1 operates by being supplied with a bootstrap voltage Vbst and the switching voltage Vsw, and generates a high-side gate control signal SX1 according to the high-side pulse control signal HGCLT fed from the delay circuit DLY0. The high-side gate control signal SX1 is at high level (≈Vbst) when the high-side pulse control signal HGCLT is at high level (≈Vreg), and is at low level (≈Vsw) when the high-side pulse control signal HGCLT is at low level (≈AGND).

The inverter INV0 inverts the logic level of the high-side gate control signal SX1 to generate an inverted high-side gate control signal S11. Accordingly, the inverted high-side gate control signal S11 is at low level when the high-side gate control signal SX1 is at high level, and is at high level when the high-side gate control signal SX1 is at low level.

The source and the back gate of the transistor P1 are both connected to an application terminal for the bootstrap voltage Vbst (i.e., a BOOT node). The drains of the transistors P1 and N5 are connected to the gate of the transistor N1 (i.e., an application terminal for the high-side gate driving signal HG). The source and the back gate of the transistor N5 are both connected to the application terminal for the switching voltage Vsw (i.e., the SW pin). The gates of the transistors P1 and N5 are both connected to the output terminal of the inverter INV0 (i.e., an application terminal for the inverted high-side gate control signal S11).

The transistors P1 and N5 connected as described above constitute an inverter that inverts the logic level of the inverted high-side gate control signal S11 to generate the high-side gate driving signal HG. Accordingly, the high-side gate driving signal HG is at low level (=Vsw) when the inverted high-side gate control signal S11 is at high level (=Vbst), and is at high level (=Vbst) when the inverted high-side gate control signal S11 is at low level (=Vsw).

The low-side gate driver 122 is a circuit block that outputs the low-side gate driving signals LG(a) to LG(d) in response to the pulse control signal PWM (i.e., the low-side pulse control signal LGCLT), and includes four buffers X2(a) to X2(d) and four inverters INV1(a) to INV1(d).

The buffers X2(a) to X2(d) all operate by being supplied with the input voltage Vin and the ground voltage PGND, and generate low-side gate control signals SX2(a) to SX2(d) respectively according to the pulse control signal PWM (i.e., a low-side pulse control signal LGCLT) fed from the controller 14. The low-side gate control signals SX2(a) to SX2(d) respectively are at high level (≈Vin) when the low-side pulse control signal LGCLT is at high level (≈Vreg), and are at low level (≈PGND) when the low-side pulse control signal LGCLT is at low level (≈AGND).

The inverters INV1(a) to INV1(d) generate low-side gate driving signals LG(a) to LG(d) by inverting the logic levels of the low-side gate control signals SX2(a) to SX2(d) respectively. The low-side gate driving signals LG(a) to LG(d) respectively are at low level (=PGND) when the low-side gate control signals SX2(a) to SX2(d) are at high level (=Vin), and are at high level (≈Vin) when the low-side gate control signals SX2(a) to SX2(d) are at low level (≈PGND).

The bootstrap circuit 13 is a circuit block that generates the bootstrap voltage Vbst, which is higher than the switching voltage Vsw, and includes a transistor P2 (e.g., a P-channel MOSFET) and a capacitor circuit CAP (corresponding to a boot capacitor).

The drain of the transistor P2 is connected to the application terminal for the input voltage Vin (i.e., the PVIN pin). The drain of the transistor P2 can be connected to an application terminal for an internal supply voltage Vref (e.g., 5 V). The source and the back gate of the transistor P2 are both connected to the application terminal for the bootstrap voltage Vbst (i.e., the boot node). The gate of the transistor P2 is fed with a bootstrap control signal S4 from the controller 14.

Note that, basically, the transistor P2 is turned on and off synchronously with the transistor N2. More specifically, the transistor P2 is on in the on period of the transistor N2 (i.e., the low-level period of the switching voltage Vsw), and is off in the off period of the transistor N2 (i.e., the high-level period of the switching voltage Vsw).

The transistor P2 is accompanied by a body diode BD3. Specifically, the drain of the transistor P2 corresponds to the anode of the body diode BD3 and the source of the transistor P2 corresponds to the cathode of the body diode BD3. In a case where only the body diode BD3 is used as a rectifying element in the bootstrap circuit 13, the gate and the source of the transistor P2 can be left short-circuited.

The capacitor circuit CAP is connected between the application terminal for the bootstrap voltage Vbst (i.e., the BOOT node) and the application terminal for the switching voltage Vsw (i.e., SW pin), and stores a charge voltage Vcap between those terminals (i.e., between BOOT and SW).

Thus, the bootstrap voltage Vbst mentioned above is a voltage (≈Vsw+Vcap) that is always higher than the switching voltage Vsw by the charge voltage Vcap. Specifically, Vbst≈Vin+Vcap in the high-level period of the switching voltage Vsw (Vsw≈Vin, N1=ON, N2=OFF), and Vbst≈PGND+Vcap in the low-level period of the switching voltage Vsw (Vsw≈PGND, N1=OFF, N2=ON).

In a case where the transistor P2 is turned on and off as a rectifying element in the bootstrap circuit 13, Vcap≈Vin−Vds (where Vds is the drain-source voltage of the transistor P2). By contrast, in a case where the transistor P2 is kept off all the time and only the body diode BD3 is used as a rectifying element in the bootstrap circuit 13, Vcap≈Vin−Vf (where Vf is the forward drop voltage across the body diode BD3).

The bootstrap voltage Vbst generated as described above is fed to the driving circuit 12 (in particular, the high-side gate driver 121) and is used as the high level of the high-side gate driving signal HG (i.e., the gate voltage for turning on the transistor N1). That is, in the on period of the transistor N1, the high level (≈Vbst) of the high-side gate driving signal HG is raised up to a voltage value (≈Vin+Vcap) higher than the high level of the switching voltage Vsw. It is thus possible to raise the gate-source voltage (=HG−SW) of the transistor N1 and reliably turn on the transistor N1.

Incorporating the capacitor circuit CAP in the power supply control device 10 will help reduce the number of discrete components that are externally connected. It is however difficult to give an incorporated capacitor circuit CAP a sufficient capacitance value.

Thus, if, for the sake of discussion, while the capacitor circuit CAP is left unmodified a single capacitor element is incorporated as the capacitor circuit CAP, when the transistor N1 turns on the electric charge stored in the capacitor circuit CAP is absorbed for the charging of the gate capacitance that accompanies the transistor N1. This may result in a drop in the bootstrap voltage Vbst and may adversely affect the driving of the gate of the transistor N1 (in particular, in turning it fully on).

To cope with that, in the power supply control device 10 according to the embodiment, the capacitor circuit CAP is configured as a doubler capacitor (i.e., voltage doubler) so that even a capacitor circuit CAP with a low capacitance is less likely to adversely affect the driving of the gate of the transistor N1.

In terms of what is shown in the diagram, the capacitor circuit CAP receives the high-side gate control signal SX1, and is configured such that it can variably control its capacitance value synchronously with the charging and discharging of the gate capacitance of the transistor N1. To achieve that, the capacitor circuit CAP includes capacitors C11 and C12, transistors N6 and N7, a transistor P3, a buffer BUF1, and an inverter INV2.

The first terminal of the capacitor C11 and the source of the transistor P3 are both connected to the application terminal for the bootstrap voltage Vbst (i.e., the BOOT node). The second terminal of the capacitor C11 is connected to the drains of the transistors N6 and N7. The gates of the transistors N7 and P3 are both connected to an application terminal for a doubler control signal DBLR. The gate of the transistor N6 is connected to an application terminal for an inverted doubler control signal XDBLR (corresponding to an inversion signal of the doubler control signal DBLR). The source of the transistor N7 and the drain of the transistor P3 are both connected to the first terminal of the capacitor C12. The source of the transistor N6 and the second terminal of the capacitor C12 are both connected to the application terminal for the switching voltage Vsw (i.e., the SW pin).

The buffer BUF1 receives the high-side gate control signal SX1 and outputs it, without changing its logic level, as the doubler control signal DBLR. Accordingly, the doubler control signal DBLR is at high level (≈Vbst) when the high-side gate control signal SX1 is at high level (≈Vbst), and is at low level (≈Vsw) when the high-side gate control signal SX1 is at low level (≈Vsw).

The inverter INV2 inverts the logic level of the doubler control signal DBLR to generate the inverted doubler control signal XDBLR. The inverted doubler control signal XDBLR is at low level (≈Vsw) when the doubler control signal DBLR is at high level (≈Vbst), and is at high level (≈Vbst) when the doubler control signal DBLR is at low level (≈Vbst).

The transistor N6 is on when the inverted doubler control signal XDBLR is at high level (≈Vbst), and is off when the inverted doubler control signal XDBLR is at low level (≈Vsw). In other words, the transistor N6 is off when the doubler control signal DBLR is at low level (≈Vbst), and is on when the doubler control signal DBLR is at low level (≈Vsw).

The transistor N7 is on when the doubler control signal DBLR is at high level (Vbst), and is off when the doubler control signal DBLR is at low level (≈Vsw),

The transistor P3 is off when the doubler control signal DBLR is at high level (Vbst), and is on when the doubler control signal DBLR is at low level (≈Vsw).

Thus, the timings of turning on and off each of the transistors N6, N7, and P3 are controlled according to the doubler control signal DBLR.

What is particular about the capacitor circuit CAP according to the embodiment is that it can be in one of the following two operating states: a first operating state where the transistors N6 and P3 are on and the transistor N7 is off (parallel-capacitor state) and a second operating state where, by contrast, the transistors N6 and P3 are off and the transistor N7 is on (series-capacitor state). These operating states will now be described in detail.

Take, first, the first operating state where the transistors N6 and P3 are on and the transistor N7 is off (parallel-capacitor state). In this state, the capacitors C11 and C12 are connected in parallel between the application terminal for the bootstrap voltage Vbst (i.e., the BOOT node) and the application terminal for the switching voltage Vsw (i.e., the SW pin). Accordingly, the combined capacitance value Ccap1 of the capacitor circuit CAP is given by Ccap1=C11+C12. Specifically, if C11=C12=75 pF, then Ccap1=150 pF. In this first operating state, the capacitors C11 and C12 are charged in parallel.

Take, next, the second operating state to which a transition from the first operating state described above takes place as a result of the transistors N6 and P3 turning off and the transistor N7 turning on. In this state, the capacitors C11 and C12 are connected in series between the application terminal for the bootstrap voltage Vbst (i.e., the BOOT node) and the application terminal for the switching voltage Vsw (i.e., the SW pin). Accordingly, the combined capacitance value Ccap2 of the capacitor circuit CAP is reduced to Ccap2=(C11·C12)/(C11+C12). Specifically, if C11=C12=75 pF, then Ccap2=37.5 pF.

Here the capacitors C11 and C12 each have been keeping in it the electric charge stored there in the first operating state. Accordingly, let the terminal-to-terminal voltage across each of the capacitors C11 and C12 immediately before the transition to the second operating state be VC, then immediately after the transition from the first operating state to the second operating state, the bootstrap voltage Vbst is raised from (VC+Vsw) to (2VC+Vsw). Thus the terminal-to-terminal voltage VC is boosted by a factor of two.

As the capacitance values of the capacitors C11 and C12 are increased, the bootstrap voltage Vbst can be raised accordingly high; this however leads to the power supply control device 10 occupying a larger layout area on a chip. So, with the tradeoff taken into consideration, the capacitance values of the capacitors C11 and C12 can be set such that the combined capacitance of the capacitor circuit CAP, Ccap2 (=(C11·C12)/(C11+C12)), is approximately one-half of the gate capacitance (e.g., 100 pF) of the transistor N1.

Needless to say, the capacitor circuit CAP can be configured in any manner other than as specifically described above so long as it can boost the terminal-to-terminal voltage VC by a factor of m (where m>1).

Instead of the capacitor circuit CAP being incorporated in the power supply control device 10, a discrete capacitor element can be externally connected to the power supply control device 10. In that case, the application terminal for the bootstrap voltage Vbst (i.e., the BOOT node) can be led out of the power supply control device 10 as a BOOT pin.

The controller 14 operates by being supplied with an internal supply voltage Vreg (e.g., 5 V) and generates the pulse control signal PWM such that from the input voltage Vin a desired output voltage Vout is generated. The output feedback control on the output voltage Vout can be achieved by any known method (such as voltage mode control, current mode control, or hysteresis control [ripple control]), and so no detailed description will be given.

The controller 14 also has a function of switching the switching power supply 1 between a heavy-load mode (HLM) and a light-load mode (LLM).

The light-load mode mentioned above is a kind of power-saving mode: in a light-load state in which the output current Iout that passes through the load is zero or very low, the switching driving of the switching output stage 11 is temporarily suspended to reduce power consumption as compared with in the heavy-load mode (ordinary mode). For example, the controller 14 can switch from the heavy-load mode (ordinary mode) to the light-load mode according to a zero-cross detection signal ZERO.

Temporarily suspending the switching driving of the switching output stage 11 requires the transistors N1 and N2 both to be off so that the application terminal for the switching voltage Vsw (i.e., SW pin) is in a high-impedance state. To achieve this, the power supply control device 10 needs to include a means (not shown in the diagram for convenience of illustration) for keeping the low-side gate driving signals LG(a) to LG(d) all fixed at low level (≈PGND) in the light-load mode regardless of the output states of the inverters INV1(a) to INV1(d).

The zero-cross detection circuit 15 monitors the switching voltage Vsw to generate pulses in the zero-cross detection signal ZERO. In terms of what is shown in the diagram, usable as the zero-cross detection circuit 15 is a comparator that generates the zero-cross detection signal ZERO by comparing the switching voltage Vsw (more precisely, the low level of the switching voltage Vsw as it appears when the transistor N1 is off and the transistor N2 is on), which is fed to the non-inverting terminal (+) of the comparator, with a threshold value voltage (e.g., the ground voltage PGND), which is fed to the inverting terminal (−) of the comparator.

In that case, the zero-cross detection signal ZERO is at low level when the low level of the switching voltage Vsw is lower than the ground voltage PGND, and is at high level when the low level of the switching voltage Vsw is higher than the ground voltage PGND. In other words, the zero-cross detection signal ZERO is at low level when the output current Iout is passing from the power-system ground terminal PGND to the application terminal for the switching voltage Vsw (i.e., the SW pin), and is at high level when the output current Iout is passing from the application terminal for the switching voltage Vsw (i.e., the SW pin) to the power-system ground terminal PGND.

### <Light-Load Mode>

Next, the switching control in the light-load mode will be described briefly. A low output current Iout passing through the load results in less energy being stored in the inductor L1 in the on period of the transistor N1. If during the on period of the transistor N2 (before the on timing of the transistor N1 in the next period) the energy stored in the inductor L1 is depleted, the output current Iout starts to pass reversely from the application terminal for the switching voltage Vsw (i.e., the SW pin) to the power-system ground terminal PGND, and this leads to a drop in the efficiency of the switching power supply 1.

To avoid that, for example, the controller 14, on detecting the zero-cross detection signal ZERO rising to high level in the on period of the transistor N2, forcibly turns off the transistor N2. This brings a state where the transistors N1 and N2 are both off, that is, a state where the switching driving of the switching output stage 11 is temporarily suspended. It is thus possible to reduce power consumption in the switching power supply 1.

On the other hand, for example, the controller 14, on detecting the output voltage Vout (or a feedback voltage corresponding to it) falling to a predetermined bottom value while the switching driving of the switching output stage 11 is being temporarily suspended, releases the transistor N2 from the forced off state and generates only one pulse in the pulse control signal PWM. This results in the transistors N1 and N2 being turned on and off complementarily only once, with the result that the output voltage Vout is raised to be kept at the target value.

After that, when the zero-cross detection signal ZERO rises to high level, the switching driving of the switching output stage 11 is temporarily suspended again. In this way, in the light-load mode, temporary suspension of switching driving through zero-cross detection (reverse flow detection) with respect to the output current Iout and resumption of switching driving through bottom detection with respect to the output voltage Vout are repeated.

Here, as the output current Iout that passes through the load increases, the output voltage Vout falls faster during temporary suspension of switching driving. Thus, as the output current Iout increases, pulses are generated at increasingly short intervals in the pulse control signal PWM. Eventually a state is reached where pulses are generated continuously at a predetermined switching period Ts in the pulse control signal PWM. This state corresponds to a state reached after a return from the light-load mode to the heavy-load mode (ordinary mode).

### <A Study on Dark Current Performance>

In a case where the power supply control device 10 is designed as a high-current model, the transistors N1 and N2 have a large size and are accompanied by a comparatively high capacitance. Thus, the charge and discharge current for the gate capacitance that is needed to generate one pulse in the pulse control signal PWM in the light-load mode is accordingly high. This can affect dark current performance, which is one index of performance in the light-load mode.

One possible method to avoid that is to divide the transistor N1 into a plurality of parts so that, in the light-load mode, only part of the transistor N1 is turned on and off; this helps reduce the charge and discharge current mentioned above. Inconveniently, this method, requiring difficult timing control in switching the number of divided parts of the transistor N1 to drive, is not necessarily the best option. Moreover, in a case where the drain-source voltage VdsH (=on resistance RonH×output current Iout) of the transistor N1 is monitored to detect an overcurrent, consideration needs to be given to how the number-of-divided-parts-to-drive control for the transistor N1 (hence the variation of the on resistance RonH) affects the overcurrent detection threshold value.

In line with the study above, a power supply control device 10 according to a second embodiment that contributes to reduction of dark current in a light-load mode will be presented below.

### Power Supply Control Device (Second Embodiment)

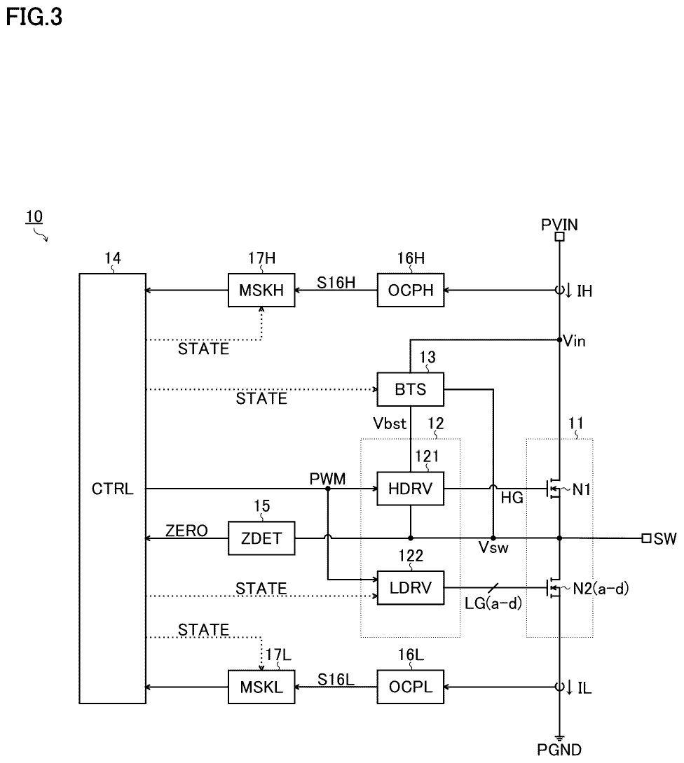

FIG. 3 is a diagram showing a power supply control device 10 according to a second embodiment. The power supply control device 10 of this embodiment is based on the first embodiment (FIG. 2) described previously and additionally includes a high-side overcurrent detection circuit 16H, a low-side overcurrent detection circuit 16L, a high-side masking circuit 17H, and a low-side masking circuit 17L.

The high-side overcurrent detection circuit 16H monitors a high-side current IH that passes in the on period of the transistor N1, and generates a high-side overcurrent detection signal S16H. For example, the high-side overcurrent detection circuit 16H checks whether the drain-source voltage VdsH (=on resistance RonH×high-side current IH) of the transistor N1 is higher than a predetermined high-side overcurrent detection threshold value VocpH, and switches the logic level of the high-side overcurrent detection signal S16H. The high-side overcurrent detection signal S16H is at high level (a logic level indicating an overcurrent being detected) when VdsH>VocpH, and is at low level (a logic level indicating no overcurrent being detected) when VdsH<VocpH.

The low-side overcurrent detection circuit 16L monitors a low-side current IL that passes in the on period of the transistor N2, and generates a low-side overcurrent detection signal S16L. For example, the low-side overcurrent detection circuit 16L checks whether the drain-source voltage VdsL (=on resistance RonL×low-side current IL) of the transistor N2 is higher than a predetermined low-side overcurrent detection threshold value VocpL, and switches the logic level of the low-side overcurrent detection signal S16L. The low-side overcurrent detection signal S16L is at high level (a logic level indicating an overcurrent being detected) when VdsL>VocpL, and is at low level (a logic level indicating no overcurrent being detected) when VdsL<VocpL.

For example, the controller 14 can forcibly suspend the switching driving of the switching output stage 11 when at least one of the high-side and low-side overcurrent detection signals S16H and S16L is at high level (i.e., the level indicating an overcurrent being detected).

The high-side masking circuit 17H is provided between the high-side overcurrent detection circuit 16H and the controller 14. According to whether a state signal STATE (i.e., a signal indicating which of the light- and heavy-load modes is in effect) output from the controller 14, the high-side masking circuit 17H determines whether to mask the high-side overcurrent detection circuit 16H. The high-side masking circuit 17H can achieve the masking, for example, by keeping the high-side overcurrent detection signal S16H fixed at low level (the logic level indicating no overcurrent being detected).

The low-side masking circuit 17L is provided between the low-side overcurrent detection circuit 16L and the controller 14. According to whether the state signal STATE output from the controller 14, the low-side masking circuit 17L determines whether to mask the low-side overcurrent detection circuit 16L. The low-side masking circuit 17L can achieve the masking, for example, by keeping the low-side overcurrent detection signal S16L fixed at low level (the logic level indicating no overcurrent being detected).

The state signal STATE output from the controller 14 is fed not only to the high-side and low-side masking circuits 17H and 17L but also to the bootstrap circuit 13 and to the low-side gate driver 122. The circuit blocks that receive the state signal STATE each perform dark current reduction operation in the light-load mode according to the state signal STATE (details will be given later).

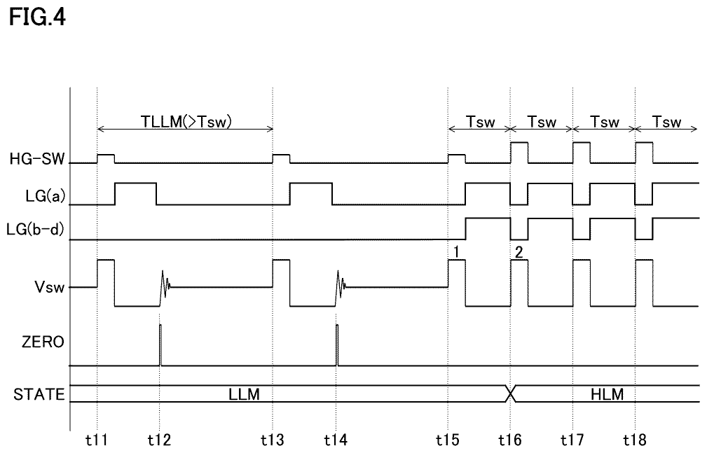

FIG. 4 is a diagram showing one example of the switching driving by the power supply control device 10 according to a second embodiment, depicting, from top down across the diagram, the gate-source voltage (=HG−SW) of the transistor N1, the low-side gate driving signal LG(a) and the low-side gate driving signals LG(b) to LG(d), the switching voltage Vsw, the zero-cross detection signal ZERO, and the state signal STATE (LLM or HLM).

With the switching power supply 1 in the heavy-load mode (STATE=HLM), the controller 14 controls the high-side and low-side gate drivers 121 and 122 individually so as to turn the transistors N1 and N2 on and off complementarily at a predetermined switching period Tsw (see time t16 and later).

By contrast, with the switching power supply 1 in the light-load mode (STATE=LLM), the controller 14 controls the high-side and low-side gate drivers 121 and 122 individually so as to repeat control for temporarily suspending switching driving through zero-cross detection (ZERO=H) with respect to the output current Iout (see times t12 and t14) and control for resuming switching driving through bottom detection with respect to the output voltage Vout (see times t11, t13, and t15).

As a result, the pulse interval TLLM in the pulse control signal PWM (not shown in the diagram) in the light-load mode is longer than the switching period Tsw in the heavy-load mode. It is thus possible to reduce switching loss in the switching output stage 11 and hence to reduce power consumption in the switching power supply 1.

As shown at times t15 and t16, if, after turning the transistors N1 and N2 on and off complementarily, the predetermined switching period Tsw elapses with no pulse generated in the zero-cross detection signal ZERO, the controller 14 switches the switching power supply 1 from the light-load mode to the heavy-load mode. That is, in response to the second of two consecutively generated pulses, the switching power supply 1 returns from the light-load mode to the heavy-load mode.

Next, the dark current reduction operation in the circuit blocks that receive the state signal STATE (the bootstrap circuit 13, the low-side gate driver 122, the high-side masking circuit 17H, and the low-side masking circuit 17L) will be described specifically, for each of those blocks.

First, the dark current reduction operation in the bootstrap circuit 13 will be described. The controller 14 controls the bootstrap circuit 13 such that it performs capacitance value switching control (doubler control) for the capacitor circuit CAP in the heavy-load mode (STATE=HLM) and it suspends capacitance value switching control (doubler control) for the capacitor circuit CAP in the light-load mode (STATE=LLM).

More specifically, in the heavy-load mode (STATE=HLM), the bootstrap circuit 13 switches the capacitor circuit CAP from the first operating state (parallel-capacitor state) to the second operating state (series-capacitor state) when the transistor N1 is turned on, and switches the capacitor circuit CAP from the second operating state (series-capacitor state) to the first operating state (parallel-capacitor state) when the transistor N1 is turned off.

That is, in the heavy-load mode (STATE=HLM), the bootstrap circuit 13 switches the capacitance value of the capacitor circuit CAP from the combined capacitance value Ccap1 to the combined capacitance value Ccap2 lower than it when the transistor N1 is turned on, and switches the capacitance value of the capacitor circuit CAP from the combined capacitance value Ccap2 to the combined capacitance value Ccap1 when the transistor N1 is turned off.

Through such capacitance value switching control (i.e., doubler control) for the capacitor circuit CAP, in the heavy-load mode (STATE=HLM), the bootstrap voltage Vbst is raised to its maximum. As a result, the gate-source voltage (=HG−SW) is fully driven (see times t16, t17, and t18). Accordingly, the on resistance of the transistor N1 is dropped to its minimum, and this brings a state that permits a higher high-side current IH to pass.

By contrast, in the light-load mode (STATE=LLM), the controller 14 keeps the capacitor circuit CAP fixed in the first operating state (i.e., parallel-capacitor state) regardless of whether the transistor N1 is on or off. That is, in the light-load mode (STATE=LLM), the capacitance value of the capacitor circuit CAP is kept fixed at the combined capacitance value Ccap1.

As described above, when capacitance value switching control (doubler control) for the capacitor circuit CAP is suspended, in the light-load mode (STATE=LLM), the bootstrap voltage Vbst is not raised to its maximum. As a result, the gate-source voltage (=HG−SW) of the transistor N1 is lower than in the heavy-load mode (STATE=HLM) (see times t11, t13, and t15). Accordingly, the on resistance RonH of the transistor N1 is higher than the minimum value mentioned above, and this makes it possible to keep the high-side current IH low and hence to reduce dark current in the light-load mode.

Next, the dark current reduction operation in the low-side gate driver 122 will be described. In the heavy-load mode (STATE=HLM), the controller 14 controls the low-side gate driver 122 such that, out of N (e.g., N=4) transistors N2(a) to N2(d), i (e.g., i=4) are turned on and off in the heavy-load mode (STATE=HLM) and only j (e.g., j=1) are turned on and off in the light-load mode (STATE=LLM).

In terms of what is shown in the diagram, in the heavy-load mode (STATE=HLM), the controller 14, when turning on and off the transistors N2(a) to N2(d) respectively, pulse-drives the low-side gate driving signals LG(a) to LG(d) all synchronously (see times t16 to t18). By contrast, in the light-load mode (STATE=LLM), the controller 14, when turning on and off the transistors N2(a) to N2(d) respectively, pulse-drives only the low-side gate driving signal LG(a) and keeps the low-side gate driving signals LG(b) to LG(d) all fixed at low level (see times t11 to t16).

In this way, by dividing the transistor N2 into a plurality of parts and turning on and off only part of the transistor N1 in the light-load mode, that is, in more general terms, by reducing the number of parts of the transistor N2 that are driven in parallel in the light-load mode as compared with in the heavy-load mode, it is possible to keep the low-side current IL low and hence to reduce dark current in the light-load mode. Note that timing control is easier in number-of-divided-parts-to-drive control for the transistor N2 than in that for the transistor N1.

Lastly, the masking operation in the high-side and low-side masking circuits 17H and 17L (i.e., erroneous detection prevention operation for the high-side and low-side overcurrent detection circuits 16H and 16L) will be described. The controller 14 controls the high-side and low-side masking circuits 17H and 17L such that they mask neither of the high-side and low-side overcurrent detection signals S16H and S16L in the heavy-load mode (STATE=HLM) and that they mask both the high-side and low-side overcurrent detection signals S16H and S16L in the light-load mode (STATE=LLM).

In the bootstrap circuit 13 and the low-side gate driver 122, when the dark current reduction operation described above is performed, the on resistances RonH and RonL of the transistors N1 and N2 vary according to the operating mode (heavy-load mode or light-load mode) of the switching power supply 1.

Accordingly, in a configuration where the high-side overcurrent detection circuit 16H monitors the drain-source voltage VdsH (=on resistance RonH×high-side current IH) of the transistor N1 to detect an overcurrent, the relationship between the drain-source voltage VdsH of the transistor N1 and the high-side overcurrent detection threshold value VocpH varies according to the operating mode (heavy-load mode or light-load mode) of the switching power supply 1, and this may interfere with the overcurrent detection operation with respect to the high-side current IH.

Likewise, in a configuration where the low-side overcurrent detection circuit 16L monitors the drain-source voltage VdsL (=on resistance RonL×low-side current IL) of the transistor N2 to detect an overcurrent, the relationship between the drain-source voltage VdsL of the transistor N2 and the low-side overcurrent detection threshold value VcopL varies according to the operating mode (heavy-load mode or light-load mode) of the switching power supply 1, and this may interfere with the overcurrent detection operation with respect to the low-side current IL.

One possible method to avoid that is, for example, to switch the high-side and low-side overcurrent detection threshold values VocpH and VocpL respectively to adequate values according to the operating mode (heavy-load mode or light-load mode) of the switching power supply 1. However, such threshold value switching control is not always easy.

By contrast, in the switching power supply 10 according to this embodiment, in the light-load mode the high-side and low-side overcurrent detection signals S16H and S16L are both masked and overcurrent detection operation is performed only in the heavy-load mode. This only requires that the high-side and low-side overcurrent detection threshold values VocpH and VocpL be set to fixed values with consideration given to the on resistances RonH and RonL of the transistors N1 and N2 in the heavy-load mode. This makes it possible to perform overcurrent detection operation in the heavy-load mode with high accuracy.

In the light-load mode, where the output current Iout that passes through the load is low in the first place, not performing overcurrent detection operation does not pose a notable problem.

### <Overview>

To follow is an overview of the various embodiments described above.

For example, according to one aspect of what is disclosed herein, a power supply control device that is configured to control a switching power supply that generates an output voltage from an input voltage includes: a high-side gate driver configured to turn on and off an N-channel high-side transistor connected between an application terminal for the input voltage and an application terminal for a switching voltage; a bootstrap circuit configured to generate a bootstrap voltage higher than the switching voltage by the charge voltage for a boot capacitor and feed the bootstrap voltage to the high-side gate driver; and a controller configured to switch the switching power supply between a heavy-load mode and a light-load mode. The bootstrap circuit can switch the capacitance value of the bootstrap capacitor according to whether the high-side transistor is on or off. The controller controls the bootstrap circuit such that, in the light-load mode, the bootstrap circuit performs capacitance value switching control for the boot capacitor and that, in the heavy-load mode, the bootstrap circuit suspends capacitance value switching control for the boot capacitor. (A first configuration.)

The power supply control device according to the first configuration described above can further include: a low-side gate driver configured to turn on and off a plurality of low-side transistors connected in parallel between the application terminal for the switching voltage and a reference potential terminal. The controller can control the low-side gate driver so as to reduce the number of low-side transistors that are driven in parallel in the light-load mode as compared with in the heavy-load mode. (A second configuration.)

The power supply control device according to the second configuration described above can further include: a low-side overcurrent detection circuit configured to generate a low-side overcurrent detection signal by monitoring a low-side current that passes through the low-side transistors; and a low-side masking circuit configured to mask the low-side overcurrent detection signal. The controller can control the low-side masking circuit such that, in the heavy-load mode, the low-side masking circuit does not mask the low-side overcurrent detection signal and that, in the light-load mode, the low-side masking circuit masks the low-side overcurrent detection signal. (A third configuration.)

The power supply control device according to the second or third configuration described above can further include: a high-side overcurrent detection circuit configured to generate a high-side overcurrent detection signal by monitoring a high-side current that passes through the high-side transistor; and a high-side masking circuit configured to mask the high-side overcurrent detection signal. The controller can control the high-side masking circuit such that, in the heavy-load mode, the high-side masking circuit does not mask the high-side overcurrent detection signal and that, in the light-load mode, the high-side masking circuit masks the high-side overcurrent detection signal. (A fourth configuration.)

In the power supply control device according to any of the first to fourth configurations described above, in the heavy-load mode, when the high-side transistor is turned on, the bootstrap circuit can switch the capacitance value of the boot capacitor from a first capacitance value to a second capacitance value lower than the first capacitance value and, when the high-side transistor is turned off, the bootstrap circuit can switch the capacitance value of the boot capacitor from the second capacitance value to the first capacitance value. (A fifth configuration.)

In the power supply control device according to the fifth configuration described above, in the light-load mode, regardless of whether the high-side transistor is on or off, the bootstrap circuit can keep the capacitance value of the boot capacitor fixed at the first capacitance value. (A sixth configuration.)

In the power supply control device according to any the first to sixth configurations described above, the controller can control the high-side gate driver such that, in the heavy-load mode, the high-side gate driver turns on the high-side transistor at a predetermined switching period and that, in the light-load mode, the high-side gate driver turns on the high-side transistor on detecting a drop in the output voltage or in a feedback voltage corresponding to the output voltage. (A seventh configuration.)

The power supply control device according to any the first to seventh configurations described above can further include: a zero-cross detection circuit configured to generate a pulse in a zero-cross detection signal by monitoring the switching voltage. The controller can switch the switching power supply from the heavy-load mode to the light-load mode according to the zero-cross detection signal. (An eighth configuration.)

In the power supply control device according to the eighth configuration described above, the controller can switch the switching power supply from the light-load mode to the heavy-load mode when, after turning off the high-side transistor, a predetermined switching period elapses with no pulse generated in the zero-cross detection signal. (A ninth configuration.)

For example, according to another aspect of what is disclosed herein, a switching power supply includes the power supply control device according to any the first to ninth configurations described above. (A tenth configuration.)

According to the disclosure herein, it is possible to provide a power supply control device and a switching power supply that can reduce dark current in a light-load mode.

### <Other Variations>

The various technical features disclosed herein may be implemented in any manners other than as in the embodiments described above, and allow for many modifications without departure from the spirit of their technical ingenuity. For example, any bipolar transistor can be replaced with a MOS field-effect transistor and vice versa. The logic levels of any signal can be inverted. That is, the embodiments described above should be taken to be in every aspect illustrative and not restrictive, and the technical scope of the present disclosure is defined by the appended claims and should be understood to encompass any modifications made within a scope equivalent in significance to what is claimed.

1. A power supply control device configured to control a switching power supply that generates an output voltage from an input voltage, comprising:
a high-side gate driver configured to turn on and off an N-channel high-side transistor connected between an application terminal for the input voltage and an application terminal for a switching voltage;
a bootstrap circuit configured to generate a bootstrap voltage higher than the switching voltage by a charge voltage for a boot capacitor and feed the bootstrap voltage to the high-side gate driver; and
a controller configured to switch the switching power supply between a heavy-load mode and a light-load mode,
wherein
the bootstrap circuit can switch a capacitance value of the bootstrap capacitor according to whether the high-side transistor is on or off, and
the controller controls the bootstrap circuit such that, in the light-load mode, the bootstrap circuit performs capacitance value switching control for the boot capacitor and that, in the heavy-load mode, the bootstrap circuit suspends the capacitance value switching control for the boot capacitor.

2. The power supply control device according to claim 1, further comprising:
a low-side gate driver configured to turn on and off a plurality of low-side transistors connected in parallel between the application terminal for the switching voltage and a reference potential terminal,
wherein
the controller controls the low-side gate driver so as to reduce a number of low-side transistors that are driven in parallel in the light-load mode as compared with in the heavy-load mode.

3. The power supply control device according to claim 2, further comprising:
a low-side overcurrent detection circuit configured to generate a low-side overcurrent detection signal by monitoring a low-side current that passes through the low-side transistors; and
a low-side masking circuit configured to mask the low-side overcurrent detection signal,
wherein
the controller controls the low-side masking circuit such that, in the heavy-load mode, the low-side masking circuit does not mask the low-side overcurrent detection signal and that, in the light-load mode, the low-side masking circuit masks the low-side overcurrent detection signal.

4. The power supply control device according to claim 2, further comprising:
a high-side overcurrent detection circuit configured to generate a high-side overcurrent detection signal by monitoring a high-side current that passes through the high-side transistor; and
a high-side masking circuit configured to mask the high-side overcurrent detection signal,
wherein
the controller controls the high-side masking circuit such that, in the heavy-load mode, the high-side masking circuit does not mask the high-side overcurrent detection signal and that, in the light-load mode, the high-side masking circuit masks the high-side overcurrent detection signal.

5. The power supply control device according to claim 1, wherein
in the heavy-load mode, when the high-side transistor is turned on, the bootstrap circuit switches the capacitance value of the boot capacitor from a first capacitance value to a second capacitance value lower than the first capacitance value and, when the high-side transistor is turned off, the bootstrap circuit switches the capacitance value of the boot capacitor from the second capacitance value to the first capacitance value.

6. The power supply control device according to claim 5, wherein
in the light-load mode, regardless of whether the high-side transistor is on or off, the bootstrap circuit keeps the capacitance value of the boot capacitor fixed at the first capacitance value.

7. The power supply control device according to claim 1, wherein
the controller controls the high-side gate driver such that, in the heavy-load mode, the high-side gate driver turns on the high-side transistor at a predetermined switching period and that, in the light-load mode, the high-side gate driver turns on the high-side transistor on detecting a drop in the output voltage or in a feedback voltage corresponding to the output voltage.

8. The power supply control device according to claim 1, further comprising:
a zero-cross detection circuit configured to generate a pulse in a zero-cross detection signal by monitoring the switching voltage,
wherein
the controller switches the switching power supply from the heavy-load mode to the light-load mode according to the zero-cross detection signal.

9. The power supply control device according to claim 8, wherein
the controller switches the switching power supply from the light-load mode to the heavy-load mode when, after turning off the high-side transistor, a predetermined switching period elapses with no pulse generated in the zero-cross detection signal.

10. A switching power supply comprising the power supply control device according to claim 1.
